(19) United States
(12) Patent Application Publication
(10) Pub. No.: US 2023/0251120 A1
(43) Pub. Date: Aug. 10, 2023

(54) Flow Rate Measurement Device

(71) Applicant: Hitachi Astemo, Ltd., Hitachinaka-shi, Ibaraki (JP)

(72) Inventors: Akira UENODAN, Hitachinaka-shi (JP); Naoki SAITO, Hitachinaka-shi (JP); Takahiro MIKI, Hitachinaka-shi (JP); Nobuaki GORAI, Hitachinaka-shi (JP)

(21) Appl. No.: 18/008,027

(22) PCT Filed: Jan. 29, 2021
(86) PCT No.: PCT/JP2021/003178

§ 371 Date: Dec. 2, 2022

(30) Foreign Application Priority Data
Jun. 5, 2020 (JP) 2020-098968

(51) Int. Cl. G01F 5/00; G01F 1/40

(52) U.S. Cl. CPC G01F 5/005; G01F 1/40

(57) ABSTRACT

According to the present invention, it is possible to provide a flow rate measurement device capable of accurately measuring a flow rate of a measurement target gas by improving anti-contamination property. A flow rate measurement device (20) of the present invention includes a board (304) disposed along a flow direction of a measurement target gas (2) in a sub passage (134), a support body (401) that is disposed to face one surface (304a) of the board, and a flow rate sensor (411) that is supported by the support body, faces the one surface of the board, and measures a flow rate of the measurement target gas passing between the support body and the board. The sub passage includes a first passage portion D1 between the support body and one surface of the board, a second passage portion D2 between the other surface of the board and a passage wall surface of the sub passage opposed thereto, and a third passage portion D3 between the support body and the passage wall surface of the sub passage that faces the support body. The support body has a first side surface (407) that faces in the flow direction of the measurement target gas in the sub passage.

### TECHNICAL FIELD

The present invention relates to a flow rate measurement device that measures, for example, a flow rate of intake air into an internal combustion engine.

### BACKGROUND ART

PTL 1 discloses a technique as an example of a flow rate measurement device.

### CITATION LIST

### Patent Literature

PTL 1: WO 2019/049513

### SUMMARY OF INVENTION

### Technical Problem

A flow rate measurement device described in PTL 1 has a structure where a flow rate detection element that is mounted on a support body is arranged in a sub passage such that the flow rate detection element faces a passage wall surface of the sub passage, and a flow path in the sub passage is divided by the support body into a flow path d1 where a measurement surface of the flow rate measurement element is disposed and a flow path d2 where the measurement surface is not disposed.

However, in a case where a contaminant in a liquid form such as water droplets and oil components enters the sub passage such that the contaminant is mixed into a measurement target gas, or in a case where a contaminant in a liquid form that adheres to a passage wall surface due to condensation or the like is dropped from the passage wall surface, there is a possibility that the contaminant directly flows into the flow path d1 and adheres to the flow rate measurement element. When the contaminant in a liquid form adheres to the flow rate measurement element, there is a possibility that the adhering contaminant may affect the accuracy of the measurement of the flow rate of a measurement target gas.

It is an object of the present invention to provide a flow rate measurement device capable of accurately measuring a flow rate of a measurement target gas by improving anti-contamination property.

### Solution to Problem

A flow rate measurement device according to the present invention that can solve the above-mentioned problem is a flow rate measurement device provided with a sub passage into which a portion of a measurement target gas that flows through a main passage is taken, the flow rate measurement device including: a board that is disposed in the sub passage along a flow direction of the measurement target gas; a support body that is disposed such that the support body faces one surface of the board in the sub passage so as to overlap with the board in a direction that intersects with a flow direction of the measurement target gas; and a flow rate sensor that faces one surface of the board in a state where the flow rate sensor is supported on the support body, and measures a flow rate of the measurement target gas passing between the support body and the board, wherein the sub passage includes a first passage portion having a first gap through which the measurement target gas passes between the support body and the one surface of the board, a second passage portion having a second gap through which the measurement target gas passes between the other surface of the board and a passage wall surface of the sub passage that faces the other surface of the board, and a third passage portion having a third gap through which the measurement target gas passes between the support body and the passage wall surface of the sub passage that faces the support body, and the support body has a side surface faces in a flow direction of the measurement target gas in the sub passage.

### Advantageous Effects of Invention

According to the present invention, it is possible to provide a flow rate measurement device capable of accurately measuring a flow rate of a measurement target gas by improving anti-contamination property. Further features related to the present invention will become apparent from the description of the present specification and the accompanying drawings. Further, problems, configurations, and advantageous effects other than those described above will become apparent by the description of embodiments made hereinafter.

### BRIEF DESCRIPTION OF DRAWINGS

FIG. 1 is a system diagram illustrating an embodiment where a physical quantity detection device according to the present invention is used in an internal combustion engine control system.

FIG. 2 is a front view of the physical quantity detection device.

FIG. 3 is a view of the physical quantity detection device as viewed in a direction indicated by an arrow III in FIG. 2.

FIG. 4 is a back view of the physical quantity detection device.

FIG. 5 is a view of the physical quantity detection device as viewed in a direction indicated by an arrow V in FIG. 2.

FIG. 6 is a plan view of the physical quantity detection device.

FIG. 7 is a bottom plan view of the physical quantity detection device.

FIG. 8 is a cross-sectional view of the physical quantity detection device taken along a line VIII-VIII in FIG. 4.

FIG. 9 is a cross-sectional view of the physical quantity detection device taken along a line IX-IX in FIG. 2.

FIG. 10 is a view of the physical quantity detection device illustrated in FIG. 2 such that a cover of the physical quantity detection device is removed.

FIG. 11 is a view of the physical quantity detection device illustrated in FIG. 10 such that a circuit board is removed from the physical quantity detection device.

FIG. 12 is a view of the physical quantity detection device illustrated in FIG. 4 in a state before an opening window of the physical quantity detection device is sealed with a resin member.

FIG. 13 is a view illustrating a front side of a board assembly.

FIG. 14 is a view illustrating a back side of the board assembly.

FIG. 15 is a perspective view of a sensor assembly.

FIG. 16 is an enlarged cross-sectional view of the sensor assembly such that only the sensor assembly is taken out from the configuration illustrated in FIG. 9.

FIG. 17 is an enlarged view schematically illustrating a main portion of the configuration illustrated in FIG. 8.

FIG. 18 is a view illustrating a modification of the configuration illustrated in FIG. 17.

FIG. 19 is a view illustrating a modification of the configuration illustrated in FIG. 17.

FIG. 20 is a view illustrating a modification of the configuration illustrated in FIG. 17.

### DESCRIPTION OF EMBODIMENTS

A mode for carrying out the invention described hereinafter (referred to as an embodiment hereinafter) solves various problems that are desired to be solved in an actual product, and solves various problems desirable to be solved when the product is used particularly as a detection device that detects a physical quantity of intake air in a vehicle. The mode can achieve various advantageous effects. One of the various problems solved by the following embodiment is the content described in the section “Technical Problem” described above, and one of the various advantageous effects achieved by the following embodiment is the advantageous effects described in the section “Advantageous Effects of Invention”. Various problems solved by the following embodiments and various advantageous effects achieved by the following embodiments will be described in the following description of the embodiments. Therefore, the technical problems solved by the embodiments and the advantageous effects achieved by the embodiments that are described in the following embodiments also contain the contents other than the contents described in the section of “Technical Problem” and the section of “Advantageous Effects of Invention”.

In the following embodiments, the same reference numerals indicate the identical constitutional elements regardless of difference in the drawing numbers, and the identical constitutional elements achieve the same functions and effects. With respect to the constitutional elements that are already described, only the reference numerals are given to the constitutional elements illustrated in the drawings, and the repeated description of these constitutional elements may be omitted.

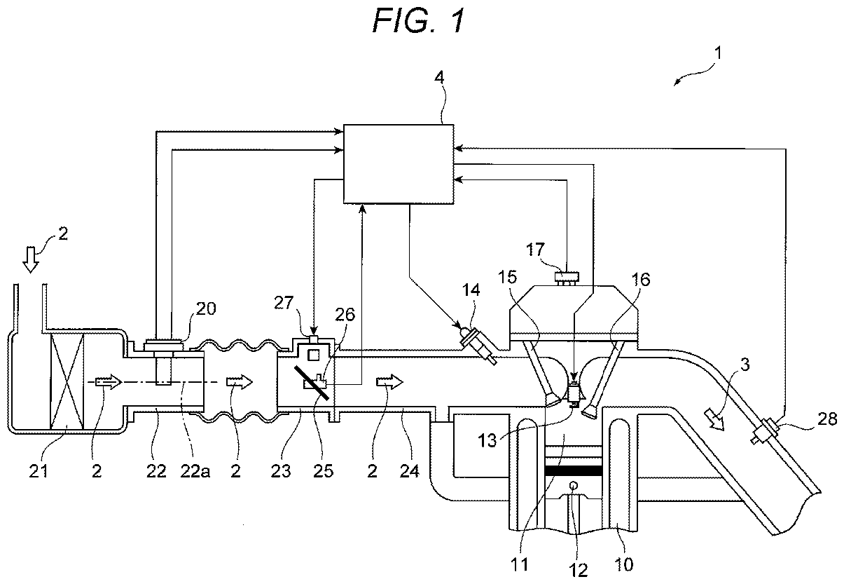

FIG. 1 is a system diagram illustrating an embodiment where a physical quantity detection device according to the present invention is used in an internal combustion engine control system 1 adopting an electronic fuel injection method. In response to an operation of an internal combustion engine 10 that includes an engine cylinder 11 and an engine piston 12, intake air is taken in from an air cleaner 21 as a measurement target gas 2. The measurement target gas 2 is introduced into a combustion chamber of the engine cylinder 11 through, for example, an intake body which forms a main passage 22, a throttle body 23, and an intake manifold 24. A physical quantity of the measurement target gas 2, that is intake air introduced into the combustion chamber, is detected by a physical quantity detection device 20. Fuel is supplied from a fuel injection valve 14 based on the detected physical quantity, and the fuel and the measurement target gas 2 are introduced into the combustion chamber in a state of an air-fuel mixture. In the present embodiment, the fuel injection valve 14 is mounted on an intake port of the internal combustion engine, and fuel injected into the intake port forms an air-fuel mixture together with the measurement target gas 2. The air-fuel mixture is introduced into the combustion chamber through an intake valve 15, and is burned so as to generate mechanical energy.

The fuel and the air introduced into the combustion chamber are in a mixed state of the fuel and the air, and an air-fuel mixture explosively burns by spark ignition of an ignition plug 13 so that mechanical energy is generated. A gas generated after combustion is introduced from an exhaust valve 16 into an exhaust pipe, and is discharged from the exhaust pipe to the outside of a vehicle as an exhaust gas 3. A flow rate of the measurement target gas 2, that is the intake air introduced into the combustion chamber, is controlled by a throttle valve 25 whose degree of opening changes based on a manipulation of an accelerator pedal. A fuel supply amount is controlled based on a flow rate of the intake air introduced into the combustion chamber. A driver can control mechanical energy generated by the internal combustion engine by controlling a flow rate of the intake air introduced into the combustion chamber, wherein such a flow rate of the intake air is controlled by controlling the degree of opening of the throttle valve 25.

Physical quantities such as a flow rate, temperature, humidity, and pressure of the measurement target gas 2, which is the intake air taken in from the air cleaner 21 and flows through the main passage 22, are detected by a physical quantity detection device 20. Electric signals representing the physical quantities of the intake air are inputted from the physical quantity detection device 20 to a controller 4. An output of a throttle angle sensor 26 that measures a degree of opening of the throttle valve 25 is inputted to the controller 4. Further, the positions and the states of the engine piston 12, the intake valve 15, and the exhaust valve 16 of the internal combustion engine are inputted to the controller 4. Still further, an output of a rotational angle sensor 17 is inputted to the controller 4 in order to measure a rotational speed of the internal combustion engine. In order to measure the state of a mixing ratio between a fuel amount and an air amount based on the state of the exhaust gas 3, an output of an oxygen sensor 28 is inputted to the controller 4.

The controller 4 calculates a fuel injection amount and an ignition timing based on a physical quantity of intake air that is an output of the physical quantity detection device 20 and a rotational speed of the internal combustion engine measured based on an output of the rotational angle sensor 17. Based on these calculation results, an amount of fuel supplied from the fuel injection valve 14 and an ignition timing at which an air-fuel mixture is ignited by the ignition plug 13 are controlled. In an actual operation, a fuel supply amount and an ignition timing are finely controlled based on change states of a temperature and a throttle angle detected by the physical quantity detection device 20, a change state of an engine rotational speed, and a state of an air-fuel ratio measured by the oxygen sensor 28. The controller 4 further controls an amount of air that bypasses the throttle valve 25 by an idle air control valve 27 in an idle operation state of the internal combustion engine, thus controlling a rotational speed of the internal combustion engine in the idle operation state.

A fuel supply amount and an ignition timing, both of which are main controlled variables of the internal combustion engine, are calculated using an output of the physical quantity detection device 20 as a main parameter. Therefore, the improvement of the detection accuracy of the physical quantity detection device 20, the suppression of a change with time of the physical quantity detection device, and the improvement of the reliability of the physical quantity detection device are important for improving the accuracy in controlling a vehicle and for securing the reliability of the vehicle.

Particularly, in recent years, a demand for fuel saving of vehicles is extremely high, and a demand for purification of an exhaust gas is also extremely high. In order to meet these demands, it is extremely important to improve the detection accuracy of a physical quantity of intake air that is detected by the physical quantity detection device 20. It is also important that the physical quantity detection device 20 maintains high reliability.

A vehicle on which the physical quantity detection device 20 is mounted is used in an environment where a change in temperature and a change in humidity are large. It is desirable that the physical quantity detection device 20 be configured by taking into account measures for coping with a change in temperature and a change in humidity in the use environment, and measures to cope with dirt, contaminants and the like.

Further, the physical quantity detection device 20 is mounted on an intake pipe that is affected by heat generated from the internal combustion engine. Accordingly, heat generated by the internal combustion engine is transmitted to the physical quantity detection device 20 through the intake pipe. The physical quantity detection device 20 detects a flow rate of a measurement target gas by performing the heat transfer with the measurement target gas. Accordingly, it is important to suppress an influence of heat from the outside as much as possible.

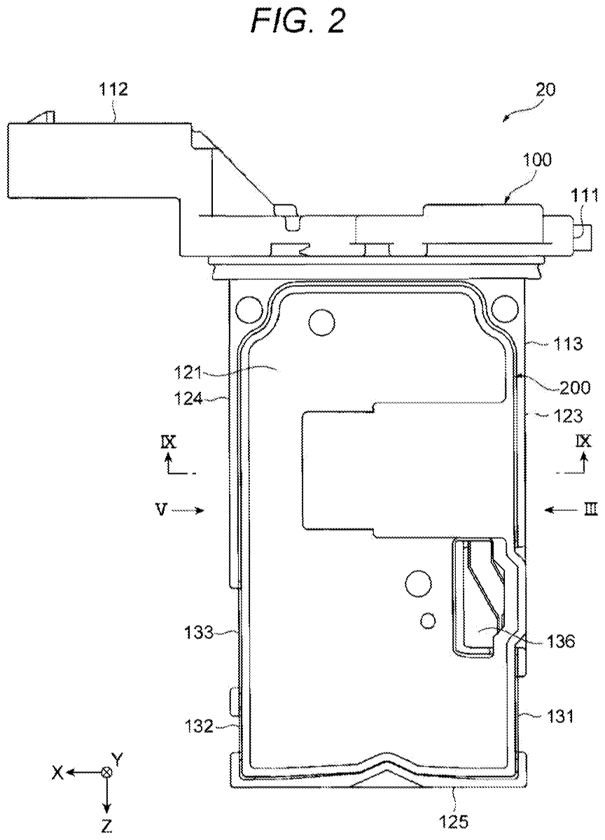

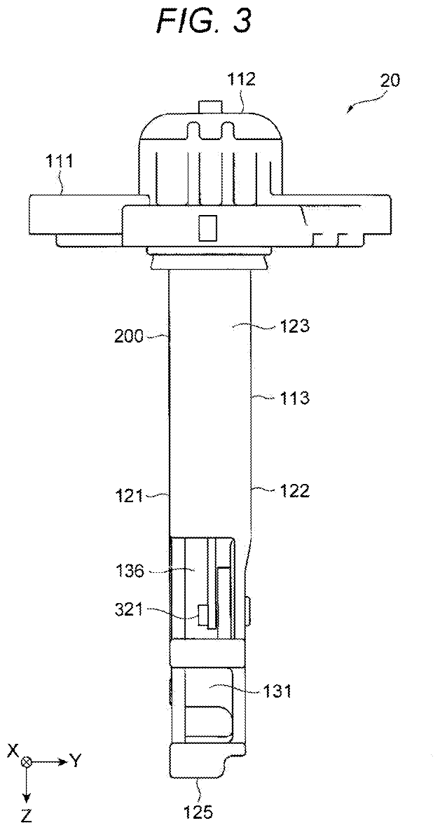

As described below, the physical quantity detection device 20 mounted on the vehicle not only simply solves the problems described in the section “Technical Problem” and achieves the advantageous effects described in the section of “Advantageous Effects of Invention”, but also solves various problems required as a product by taking into account the various problems described above, and achieves various advantageous effects as described below. Specific problems to be solved and specific advantageous effects that can be achieved by the physical quantity detection device 20 will be described in the description of embodiments made hereinafter.

<First embodiment> FIG. 2 to FIG. 7 are views illustrating an external appearance of a physical quantity detection device. In the description made hereinafter, it is assumed that a measurement target gas 2 flows along a central axis 22A of a main passage 22. The physical quantity detection device 20 of the present embodiment also has a function of operating as a flow rate measurement device for measuring a flow rate that is one of physical quantities of the measurement target gas 2.

The physical quantity detection device 20 is used such that the physical quantity detection device 20 is inserted into the main passage 22 from a mounting hole formed in a passage wall of the main passage 22 and is fixed to the main passage 22. The physical quantity detection device 20 includes a housing that is disposed in the main passage 22 through which a measurement target gas flows. The housing of the physical quantity detection device 20 includes a housing 100 and a cover 200 mounted on the housing 100. The housing 100 is formed by injection molding using a synthetic resin material, for example.

The cover 200 is formed of, for example, a plate-like member made of a metal material or a synthetic resin material. In the present embodiment, the cover is formed of an injection molded article made of an aluminum alloy or a synthetic resin material. As illustrated in FIG. 2, the cover 200 has a size that allows the cover 200 to entirely cover a front surface of the housing 100.

The housing 100 includes a flange 111 for fixing the physical quantity detection device 20 to an intake body that forms the main passage 22, a connector 112 that protrudes from the flange 111 and is exposed to the outside from the intake body for electrical connection with an external device, and a measurement unit 113 that extends from the flange 111 in a protruding manner toward the center of the main passage 22.

The measurement unit 113 is inserted into the main passage 22 through a mounting hole provided to the main passage 22. The flange 111 of the physical quantity detection device 20 is brought into contact with the main passage 22, and is fixed to the main passage 22 by screws.

The measurement unit 113 has a thin and long shape extending straight from the flange 111, and includes a wide front surface 121 and a wide back surface 122, and a pair of narrow side surfaces 123 and 124. The measurement unit 113 protrudes from an inner wall of the main passage 22 toward the passage center of the main passage 22 such that the physical quantity detection device 20 is mounted on the main passage 22. The front surface 121 and the back surface 122 are arranged in parallel along the central axis 22A of the main passage 22. Out of the narrow side surfaces 123 and 124 of the measurement unit 113, the side surface 123 on one side in the longitudinal direction of the measurement unit 113 is arranged to face the upstream side (air cleaner side) of the main passage 22, and the side surface 124 on the other side in the short direction of the measurement unit 113 is arranged to face the downstream side (engine side) of the main passage 22.

In the present embodiment, such that the physical quantity detection device 20 is mounted on the main passage 22, a proximal end portion of the measurement unit 113 is disposed on an upper side, and a distal end portion of the measurement unit 113 is disposed on a lower side. A lower surface 125 is formed on the distal end portion of the measurement unit 113. However, the posture state of the physical quantity detection device 20 in use is not limited to the posture state described in the present embodiment. The physical quantity detection device 20 can take various postures. For example, the physical quantity detection device 20 may take a posture state where the proximal end portion and the distal end portion of the measurement unit 113 are horizontally mounted on the main passage 22 such that the proximal end portion and the distal end portion of the measurement unit 113 have the same height.

In the following description, there may be a case where an axis of the measurement unit 113 in a longitudinal direction, that is a direction in which the measurement unit 113 extends from the flange 111 is referred to as a Z axis, an axis of the measurement unit 113 in a short direction, that is a direction in which the measurement unit 113 extends from a sub passage inlet 131 of the measurement unit 113 toward a first outlet 132 is referred to as an X axis, and an axis of the measurement unit 113 in a thickness direction, that is a direction from the front surface 121 toward the back surface 122 is referred to as a Y axis.

In the measurement unit 113, a sub passage inlet 131 is formed in a side surface 123 disposed on one side in the X-axis direction, and the first outlet 132 and a second outlet 133 are formed in a side surface 124 on the other side in the X-axis direction. The sub passage inlet 131, the first outlet 132, and the second outlet 133 are formed in a distal end portion of the measurement unit 113 that extends in the Z-axis direction from the flange 111 toward the center of the main passage 22. Therefore, with respect to a measurement target gas 2 that flows through the main passage 22, a portion of the measurement target gas 2 positioned close to the central portion of the main passage 22 away from the inner wall surface of the main passage 22 can be taken into a sub passage 134. Therefore, the physical quantity detection device 20 can measure a flow rate of the portion of a measurement target gas 2 away from the inner wall surface of the main passage 22 and hence, it is possible to suppress the lowering of accuracy in measurement caused by an influence of heat or the like.

The measurement unit 113 has a shape where the measurement unit 113 extends in an elongated manner along the Z axis from an outer wall of the main passage 22 toward the center of the main passage 22, while the widths of the side surfaces 123 and 124 in the Y axis direction are narrow. With such a shape, the physical quantity detection device 20 can suppress a fluid resistance to a small value with respect to the measurement target gas 2.

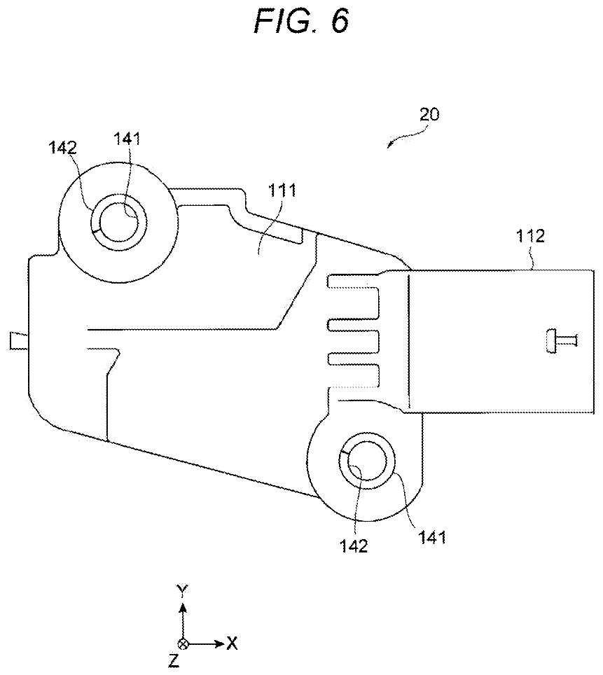

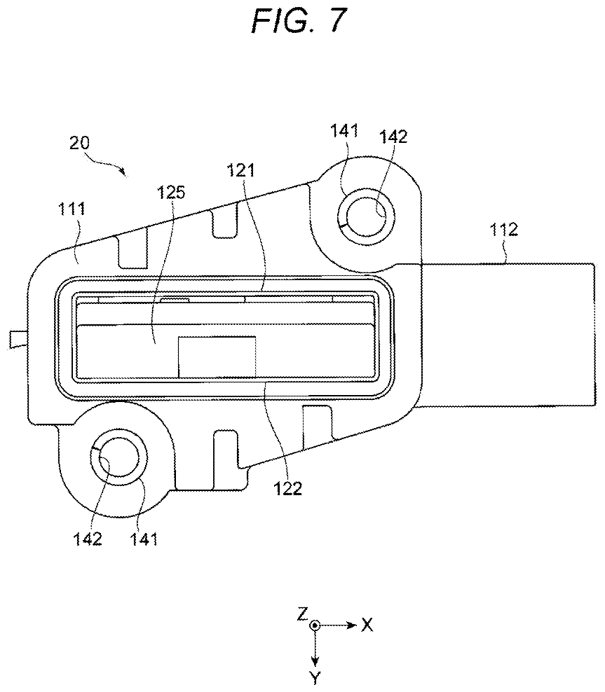

The measurement unit 113 is inserted into the main passage 22 through a mounting hole formed in the main passage 22. The flange 111 is brought into contact with the main passage 22, and is fixed to the main passage 22 by screws. The flange 111 has a substantially rectangular shape as viewed in a plan view and having a predetermined plate thickness. As illustrated in FIG. 6 and FIG. 7, fixing hole portions 141 are formed in pairs at corner portions disposed on a diagonal line. The fixing hole portion 141 has a through hole 142 that penetrates the flange 111. The flange 111 is fixed to the main passage 22 in such a manner that fixing screws (not illustrated) are made to pass through the through holes 142 of the fixing hole portions 141 and the fixing screws are made to threadedly engage with the screw holes formed in the main passage 22.

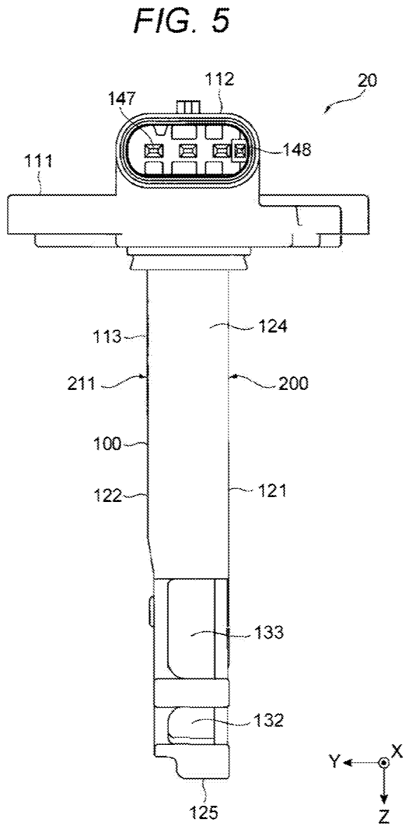

As illustrated in FIG. 5, three external terminals 147 and a correction terminal 148 are disposed in the connector 112. The external terminals 147 are formed of: terminals for outputting physical quantities such as a flow rate and a temperature which are a measurement result of the physical quantity detection device 20; and a power supply terminal for supplying DC power to operate the physical quantity detection device 20. The correction terminal 148 is a terminal used for measuring the physical quantity detection device 20 that is produced, obtaining a correction value related to each physical quantity detection device 20, and storing the correction value in the memory in the physical quantity detection device 20. In the succeeding measurement operation performed by the physical quantity detection device 20, correction data representing the correction value stored in the memory is used. The correction terminal 148 is not used thereafter.

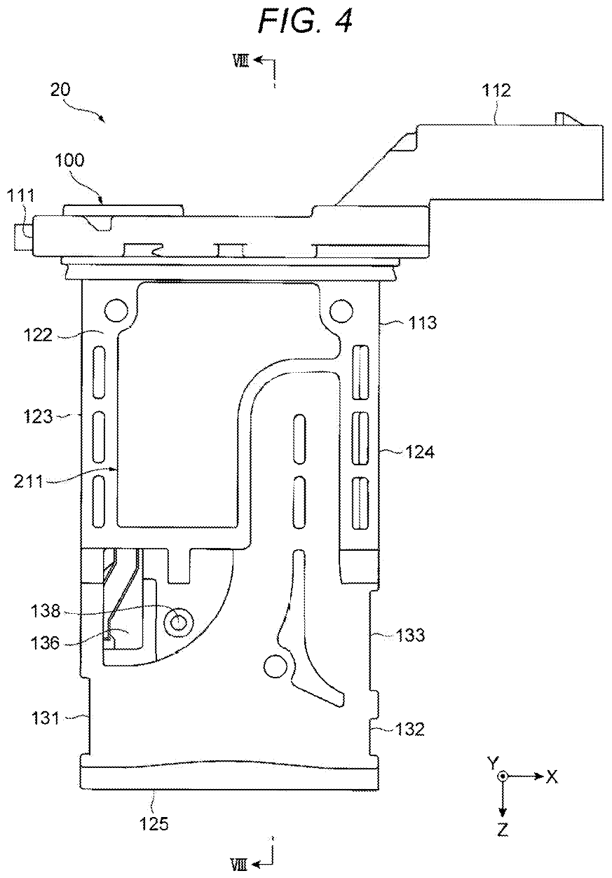

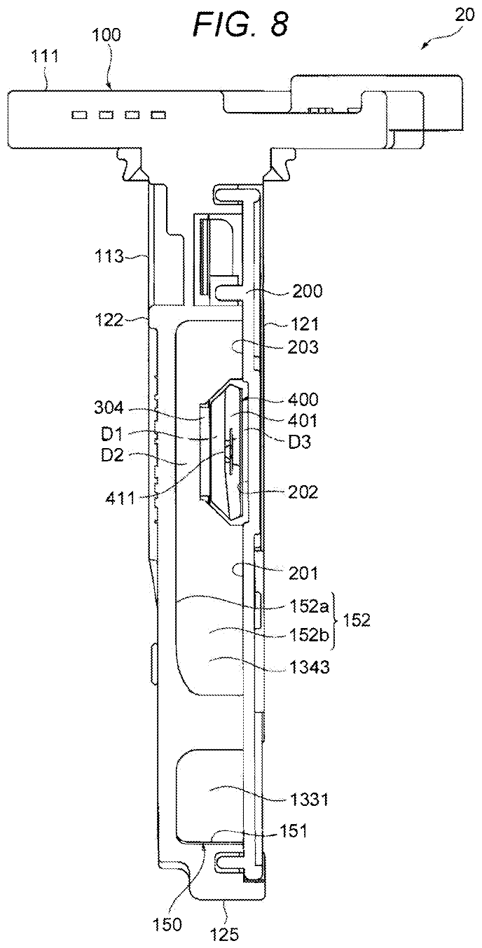

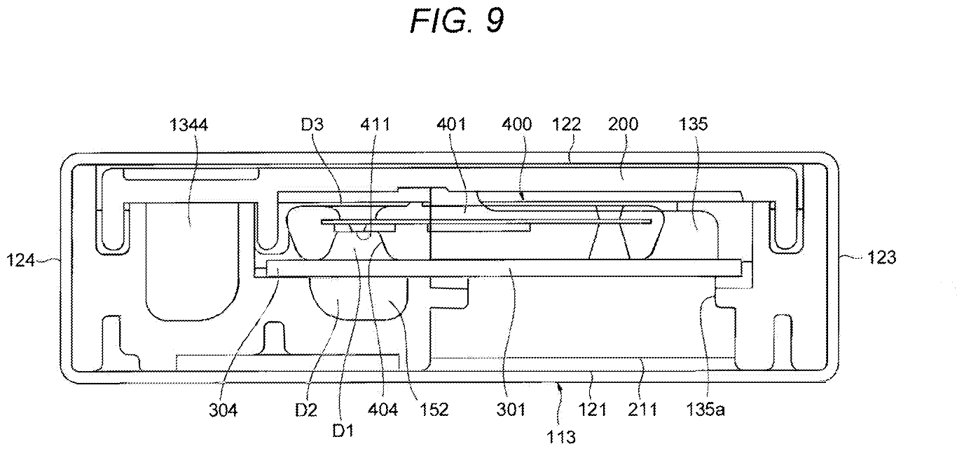

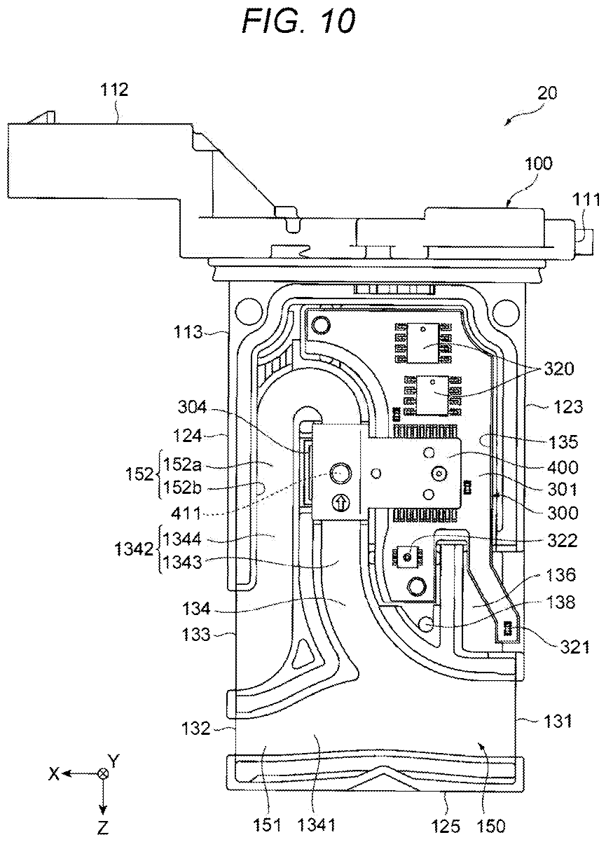

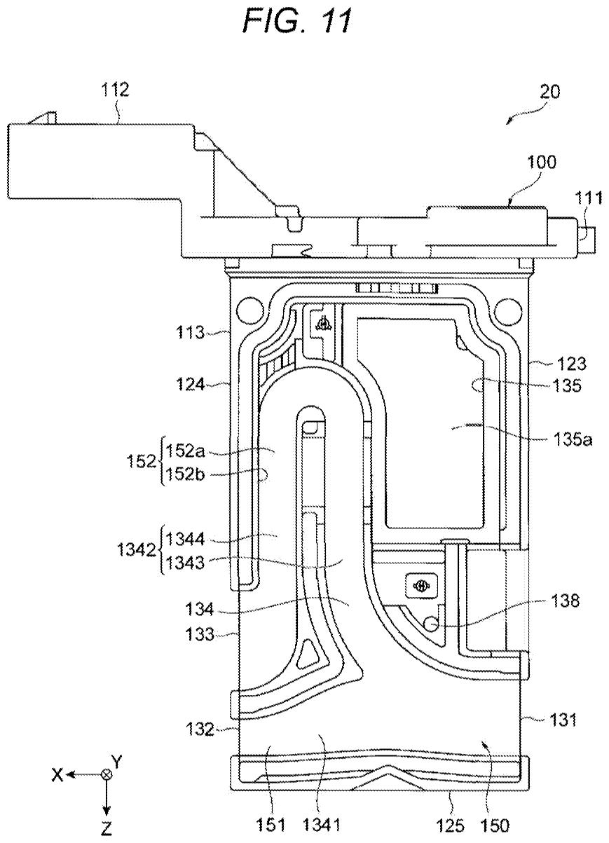

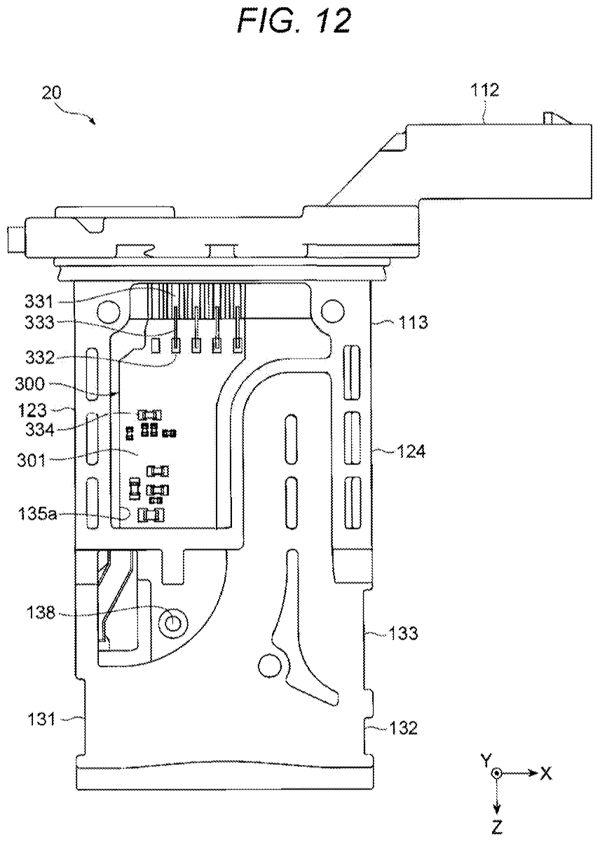

FIG. 8 is a cross-sectional view of the physical quantity detection device taken along a line VIII-VIII in FIG. 4. FIG. 9 is a cross-sectional view of the physical quantity detection device taken along a line IX-IX in FIG. 2. FIG. 10 is a view of the physical quantity detection device illustrated in FIG. 2 such that a cover of the physical quantity detection device is removed. FIG. 11 is a view of the physical quantity detection device illustrated in FIG. 10 such that a circuit board is removed. FIG. 12 is a view of the physical quantity detection device illustrated in FIG. 4 in a state before an opening window of the physical quantity detection device is sealed.

The measurement unit 113 of the housing 100 includes a flow rate sensor 411 that is a flow rate detection element, an intake air temperature sensor 321, and a humidity sensor 322. The flow rate sensor 411 detects a flow rate of a measurement target gas 2 flowing through the main passage. The flow rate sensor 411 has a diaphragm structure, and is disposed in the intermediate portion of the sub passage 134. The intake air temperature sensor 321 is disposed in an intermediate portion of a temperature detection passage 136 having one end thereof opened in the vicinity of the sub passage inlet 131 formed in the side surface 123 and the other end thereof opened to both the front surface 121 and the back surface of the measurement unit 113. The intake air temperature sensor 321 detects a temperature of a measurement target gas 2 that flows through the main passage. The humidity sensor 322 is disposed in a humidity measurement chamber 137 of the measurement unit 113. The humidity sensor 322 measures a humidity of a measurement target gas taken into the humidity measurement chamber 137 from the window portion 138 that opens on a back surface of the measurement unit 113.

The measurement unit 113 includes a sub passage groove 150 for forming the sub passage 134 and a circuit chamber 135 for accommodating a circuit board 300. The circuit chamber 135 and the sub passage groove 150 are formed such that the circuit chamber 135 and the sub passage groove 150 make the front surface 121 of the measurement unit 113 recesses, and configured to be covered by mounting a cover 200 on the front surface 121 of the measurement unit 113.

The circuit chamber 135 is provided in a region on one side (side surface 123 side) in the X-axis direction which is a position on the upstream side in the flow direction of the measurement target gas 2 in the main passage 22. An opening window 135a that penetrates the measurement unit 113 in the Y-axis direction is formed in the circuit chamber 135. The opening window 135a opens on a back surface of the measurement unit 113. With such a configuration, such that the circuit board 300 is mounted the measurement unit 113, it is possible to partially expose the back surface of the circuit board 300. The opening window 135a exposes at least a bonding pad 332 out of a back surface of the circuit board 300. With such a configuration, the bonding pad 332 and a connection terminal 331 of the measurement unit 113 can be connected to each other by a wire 333. After the bonding pad 332 and the connection terminal 331 are connected to each other by the wire 333, the opening window 135a is completely closed by being filled with a curing agent such as an epoxy resin.

The sub passage groove 150 is formed over an area on a more distal end side in the Z axis direction (lower surface 125 side) of the measurement unit 113 than the circuit chamber 135, and an area on the other side in the X axis direction (side surface 124 side) that is positioned on a more downstream side in the flow direction of the measurement target gas 2 in the main passage 22 than the circuit chamber 135.

The sub passage groove 150 forms the sub passage 134 in cooperation with the cover 200 that covers the front surface 121 of the measurement unit 113. The sub passage groove 150 includes a first sub passage groove 151, and a second sub passage groove 152 that branches from an intermediate portion of the first sub passage groove 151. The first sub passage groove 151 is formed in an extending manner along the X-axis direction of the measurement unit 113 between a sub passage inlet 131 that opens in the side surface 123 of the measurement unit 113 on one side and the first outlet 132 that opens in a side surface 124 of the measurement unit 113 on the other side. The first sub passage groove 151 forms, in cooperation with the cover 200, a first sub passage 1331 that takes in the measurement target gas 2 flowing in the main passage 22 from the sub passage inlet 131 and returns the taken measurement target gas 2 from the first outlet 132 to the main passage 22. The first sub passage 1331 has a flow path that extends from the sub passage inlet 131 along the flow direction of the measurement target gas 2 in the main passage 22 and is connected to the first outlet 132.

The second sub passage groove 152 is branched from an intermediate portion of the first sub passage groove 151, is bent toward a proximal end portion side (flange side) of the measurement unit 113, and extends along the Z-axis direction of the measurement unit 113. Subsequently, the second sub passage groove 152 is bent toward the other side (side surface 124 side) in the X-axis direction of the measurement unit 113 at the proximal end portion of the measurement unit 113 thus making a U turn toward the distal end portion of the measurement unit 113, and extends again along the Z-axis direction of the measurement unit 113. Subsequently, the second sub passage groove 152 is bent toward the other side (side surface 124 side) in the X-axis direction of the measurement unit 113 in front of the first outlet 132, and the second sub passage groove 152 is continuously formed with the second outlet 133 that opens on the side surface 124 of the measurement unit 113. The second outlet 133 is disposed such that the second outlet 133 faces toward the downstream side of the main passage 22 in the flow direction of the measurement target gas 2. The second outlet 133 has an opening area slightly larger than an opening area of the first outlet 132. The second outlet 133 is formed at a position more adjacently to the proximal end side of the measurement unit 113 in the longitudinal direction than the first outlet 132.

The second sub passage groove 152 forms, in cooperation with the cover 200, a second sub passage 1332 that allows the measurement target gas 2 that is branched from the first sub passage 1331 and flows into the second sub passage groove 152 to pass through the second sub passage groove 152 and returns the measurement target gas 2 from the second outlet 133 to the main passage 22. The second sub passage 1332 has a flow path that outgoes and returns along the Z-axis direction of the measurement unit 113. That is, the second sub passage 1332 includes an outgoing passage portion 1333 that is branched from the intermediate portion of the first sub passage 1331 and extends toward the proximal end portion side of the measurement unit 113 (direction away from the first sub passage 1331), and an incoming passage portion 1334 that makes a U turn by being folded back at the proximal end portion side of the measurement unit 113 (end portion of the outgoing passage portion 1333) and extends toward the distal end portion side of the measurement unit 113 (direction approaching the first sub passage 1331). The incoming passage portion 1334 has a flow path connected to the second outlet 133 that opens toward the downstream side in the flow direction of the measurement target gas 2 at a position disposed on the more downstream side in the flow direction of the measurement target gas 2 in the main passage 22 than the sub passage inlet 131.

In the second sub passage 1332, a flow rate sensor (flow rate detection unit) 411 is disposed at an intermediate portion of the outgoing passage portion 1333. The second sub passage 1332 is formed such that the second sub passage 1332 extends along the longitudinal direction of the measurement unit 113 and makes a round trip. Accordingly, the second sub passage 1332 can ensure a longer passage length and hence, when pulsation occurs in the main passage, an influence of the pulsation exerted on the flow rate sensor 411 can be reduced. The flow rate sensor 411 is mounted on the sensor assembly 400, and the sensor assembly 400 is mounted on the circuit board 300.

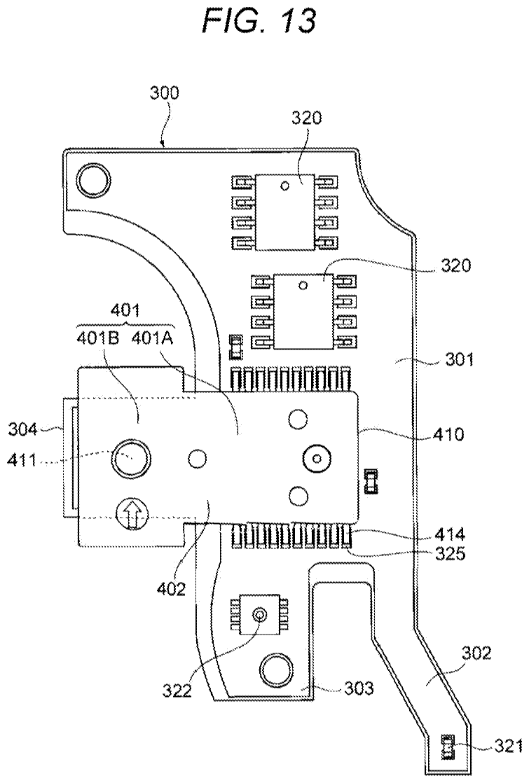

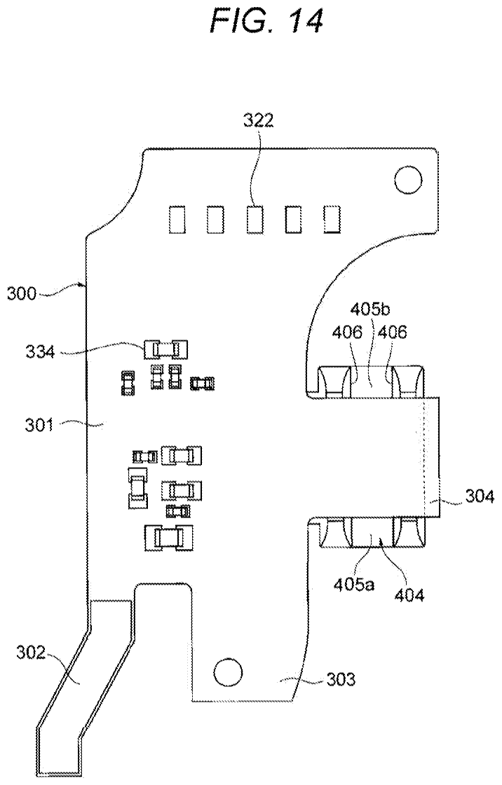

FIG. 13 is a view illustrating a front side of the board assembly, and FIG. 14 is a view illustrating a back side of the board assembly.

In the circuit board 300, circuit components such as a sensor assembly 400, a pressure sensor 320, an intake air temperature sensor 321, a humidity sensor 322 and the like are mounted on a mounting surface on the front side, and circuit components 334 such as chip resistors and chip capacitors and bonding pads 332 are mounted on a mounting surface on the back side. The circuit board 300 has a substantially rectangular shape in plan view. As illustrated in FIG. 10, the circuit board 300 is disposed in the measurement unit 113 such that a longitudinal direction of the circuit board 300 extends from a proximal end portion toward a distal end portion of the measurement unit 113, and a lateral direction of the circuit board 300 extends from the side surface 123 toward the side surface 124 of the measurement unit 113.

The circuit board 300 includes a board body 301 disposed in the circuit chamber 135. On the board body 301, a first protrusion 302 that is disposed in the temperature detection passage 136, a second protrusion 303 that is disposed in a humidity measurement chamber 137, and a third protrusion 304 that is disposed in the outgoing passage portion 1333 of the second sub passage 1332 are mounted in such a manner that the first protrusion 302, the second protrusion 303 and the third protrusion 304 respectively extend from the board body 301 in a coplanar array. The intake air temperature sensor 321 is mounted on a distal end portion of the first protrusion 302, and a humidity sensor 322 is mounted on the second protrusion 303. The third protrusion 304 is disposed in the outgoing passage portion 1333 of the second sub passage 1332 such that the third protrusion 304 faces the sensor assembly 400. The third protrusion 304 that is disposed on the circuit board 300 closes an open portion of a recessed groove 404 formed on the sensor assembly 400 so as to form a first passage portion D1. A second passage portion D2 is formed between the third protrusion 304 that is disposed on the circuit board 300 and a bottom wall surface 152a of the second sub passage groove 152.

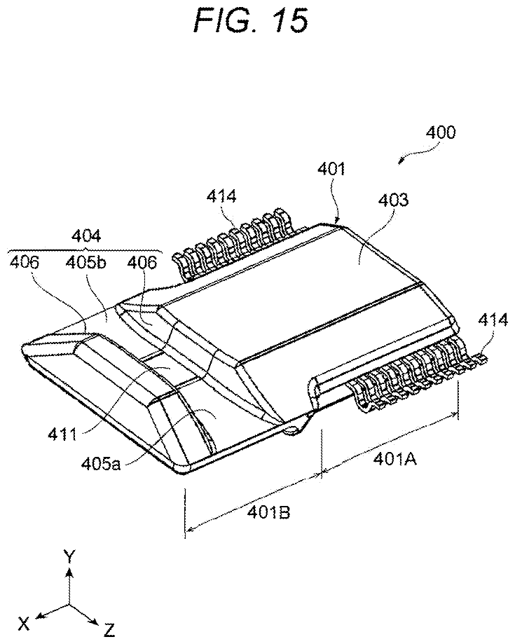

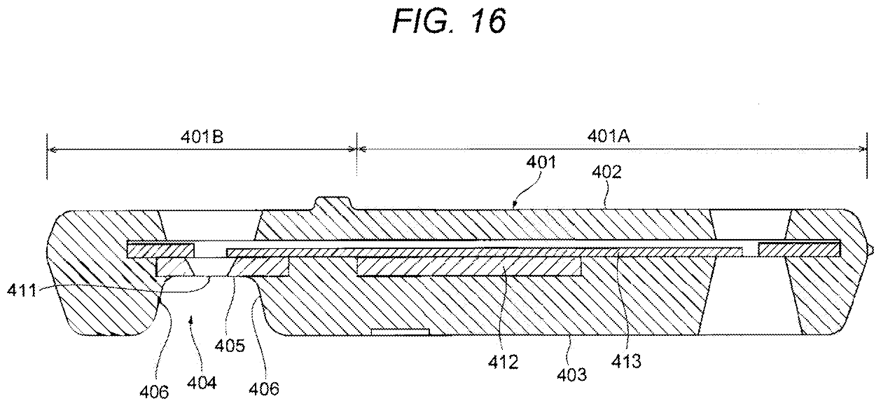

FIG. 15 is a perspective view of the sensor assembly according to the first embodiment, and FIG. 16 is an enlarged cross-sectional view of the sensor assembly such that only the sensor assembly is taken out from the configuration illustrated in FIG. 9.

The sensor assembly 400 has a resin package structure where the flow rate sensor 411, an LSI 412, and a lead frame 413 are sealed by a molding resin. The flow rate sensor 411 and the LSI 412 are mounted on the lead frame 413. The sensor assembly 400 is formed by sealing the flow rate sensor 411 by a resin such that a diaphragm of the flow rate sensor 411 is exposed. The sensor assembly 400 includes a flat plate-shaped support body 401 that is formed by molding resin and has a predetermined plate thickness. In the sensor assembly 400, a proximal end portion 401A of the support body 401 is disposed in the circuit chamber 135, and a distal end portion 401B of the support body 401 is disposed such that the distal end portion 401B protrudes into the second sub passage groove 152. The sensor assembly 400 is electrically connected to the circuit board 300 and is mechanically fixed to the circuit board 300 by a fixing portion.

A plurality of connection terminals 414 are mounted on the proximal end portion 401A of the support body 401. The plurality of connection terminals 414 are mounted such that the plurality of connection terminals 414 protrude from both ends of the proximal end portion 401A of the support body 401 in a width direction in directions away from each other along the width direction (Z axis in FIG. 15) of the support body 401. A distal end of each connection terminal 414 is bent in a thickness direction of the proximal end portion 401A and is disposed at a position protruding more in the thickness direction (Y axis in FIG. 15) than a front surface 403 of the proximal end portion 401A.

A distal end portion 401B of the support body 401 is disposed in the outgoing passage portion 1333 of the second sub passage 1332 such that the distal end portion 401B faces the third protrusion 304 mounted on the circuit board 300. A recessed groove 404 is formed on the distal end portion 401B of the support body 401. The recessed groove 404 is formed on the front surface 403 of the distal end portion 401B of the support body 401 such that the recessed groove 404 extends in a width direction (Z axis in FIG. 15) of the distal end portion 401B of the support body 401. The flow rate sensor 411 is disposed in an exposed manner at an intermediate position of the recessed groove 404 in the extending direction.

The recessed groove 404 has bottom surfaces 405a, 405b that extend in directions away from the flow rate sensor 411 and opposite to each other, and a pair of wall surfaces 406 that face each other. The bottom surface 405a is formed in an inclined manner such that a groove depth is gradually decreased as the bottom surface 405a shifts to an end on one side in the width direction of the support body 401 toward the flow rate sensor 411. On the other hand, the bottom surface 405b is formed flat so as to have a constant groove depth between an end on the other side in the width direction of the support body 401 and the flow rate sensor 411. The pair of wall surfaces 406 has a squeezed shape such that the wall surfaces 406 gradually approach to each other from both ends in the width direction of the support body 401 as the wall surfaces 406 are disposed closer to the flow rate sensor 411.

The sensor assembly 400 is preferably formed into a squeezed shape by sealing the flow rate sensor 411 using a resin. This is because, with such a configuration, a positional relationship between a squeezed portion and the measurement unit can be determined with high accuracy and hence, the measurement accuracy can be improved. Further, compared with a case where the flow of air is squeezed in a direction perpendicular to a measurement surface, an amount of air containing contaminants that is guided by the measurement surface can be reduced by squeezing the flow of air in a direction parallel to the measurement surface. Accordingly, the flow rate sensor is also excellent in anti-contamination property. It may be also possible to adopt a configuration where the LSI 412 and the flow rate sensor 411 are integrally formed with each other or the configuration where the LSI 412 is fixed to the circuit board 300. Further, the sensor assembly 400 may have a structure where the flow rate sensor 411 is mounted on a resin molded body (sensor support body) where metal terminals are sealed by a resin. The sensor assembly 400 is a support body that includes at least the flow rate sensor 411 and a member that support the flow rate sensor 411.

The sensor assembly 400 is disposed such that the recessed groove 404 extends along the outgoing passage portion 1333 of the second sub passage 1332. The sensor assembly 400 is disposed such that the flow rate sensor 411 faces the third protrusion 304 that is a portion of the circuit board 300. In the sensor assembly 400, the first passage portion D1 is formed between the passage wall 314 of the support body 401 and the third protrusion 304 of the circuit board 300. A measurement target gas that flows through the second sub passage 1332 passes through the first passage portion D1, and a flow rate of the measurement target gas is detected by the flow rate sensor 411.

The sensor assembly 400 is fixed to the circuit board 300 by soldering the connection terminals 414 to the circuit board 300. That is, a soldered portion forms a fixing portion that electrically connects the sensor assembly 400 and the circuit board 300 to each other and mechanically fixes the sensor assembly 400 to the circuit board 300. However, a fixing method for fixing the sensor assembly 400 to the circuit board 300 is not limited to soldering. For example, it may be possible to adopt a press-fit method where a plurality of connection terminals are formed of press-fit terminals, and these press-fit terminals are connected to the circuit board 300 by inserting the press-fit terminals into through holes formed in the circuit board 300. Alternatively, it may be also possible to adopt a method where a conductive adhesive such as a silver paste is applied so as to bond and fix the plurality of connection terminals 414 to connection pads of the circuit board 300.

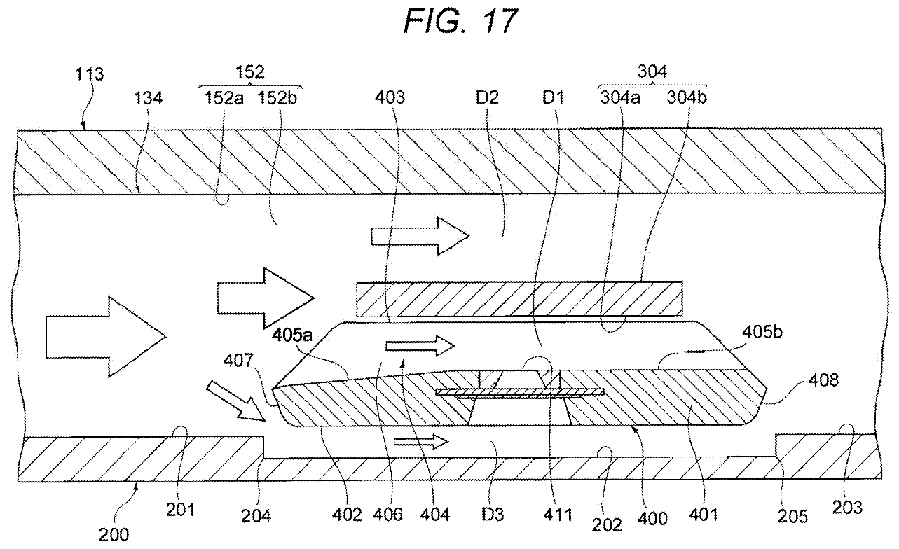

FIG. 17 is an enlarged view schematically illustrating a main portion of the configuration illustrated in FIG. 8.

The third protrusion 304 of the circuit board 300 is disposed such that one surface 304a and the other surface 304b are disposed along the passage direction of the sub passage 134, that is the flow direction of a measurement target gas, in the sub passage 134. The support body 401 of the sensor assembly 400 is disposed at a position where the support body 401 faces one surface 304a of the third protrusion 304.

The support body 401 of the sensor assembly 400 is disposed in the sub passage 134 in a facing manner with the third protrusion 304 of the circuit board 300 such that the support body 401 overlaps with the third protrusion 304 in a direction that intersects with the flow direction of a measurement target gas. Hereinafter, the direction in which the third protrusion 304 of the circuit board 300 and the support body 401 of the sensor assembly 400 overlap with each other may be also referred to as a stacking direction. The support body 401 of the sensor assembly 400 is disposed such that the recessed groove 404 extends along the passage direction of the sub passage 134. The third protrusion 304 of the circuit board 300 and the sensor assembly 400 correspond to a board and a support body in claims, respectively.

The recessed groove 404 of the support body 401 is covered by the third protrusion 304 of the circuit board 300, and the first passage portion D1 that has a closed cross section and allows a measurement target gas to flow therethrough is formed between the support body 401 and the circuit board 300. The first passage portion D1 has a first gap between the bottom surfaces 405a and 405b of the recessed groove 404 and one surface 304a of the third protrusion 304 of the circuit board 300. The flow rate sensor 411 that is exposed in the recessed groove 404 of the support body 401 is disposed such that the flow rate sensor 411 faces one surface 304a of the third protrusion 304 of the circuit board 300. The flow rate sensor 411 measures a flow rate of a measurement target gas that passes through between the support body 401 and the third protrusion 304 of the circuit board 300.

The third protrusion 304 of the circuit board 300 is disposed at a position away from the bottom wall surface 152a of the second sub passage groove 152 in the sub passage 134. The second passage portion D2 that has a closed cross section and allows a measurement target gas to flow therethrough is formed between the third protrusion 304 of the circuit board 300 and the bottom wall surface 152a of the second sub passage groove 152. The second passage portion D2 has a second gap through which a measurement target gas passes between the third protrusion 304 of the circuit board 300 and the bottom wall surface 152a of the second sub passage groove 152.

The support body 401 is disposed at a position away from the cover 200 in the sub passage 134. A third passage portion D3 that has a closed cross section and allows a measurement target gas to flow therethrough is formed between the support body 401 and the cover 200 in the sub passage 134. The third passage portion D3 has a third gap between the support body 401 and the cover 200.

That is, in the sub passage 134, the first passage portion D1 having the first gap through which a measurement target gas flows between the third protrusion 304 of the circuit board 300 and the recessed groove 404 of the support body 401, the second passage portion D2 having the second gap through which the measurement target gas flows between the third protrusion 304 of the circuit board 300 and the bottom wall surface 152a of the second sub passage groove 152, and the third passage portion D3 having the third gap through which the measurement target gas flows between the back surface 402 of the support body 401 and the cover 200 are formed.

The first passage portion D1 to the third passage portion D3 are arranged side by side in a stacking direction in which the third protrusion 304 and the support body 401 face each other in the sub passage 134. That is, the sub passage 134 is divided into three passage portions D1 to D3 in the stacking direction at the intermediate portion thereof where the flow rate sensor 411 is disposed.

The third protrusion 304 of the circuit board 300 and the support body 401 are brought into contact with neither the bottom wall surface 152a nor the cover 200 of the second sub passage groove 152 that form the passage wall surface of the sub passage 134 in a cooperative manner and hence, the third protrusion 304 of the circuit board 300 and the support body 401 are disposed in a state of floating in the air in the sub passage 134. That is, the third protrusion 304 of the circuit board 300 and the support body 401 are at an intermediate position in a groove depth direction of the second sub passage groove 152. The flow rate sensor 411 is disposed at the position where the flow rate sensor 411 faces only the third protrusion 304 of the circuit board 300 and faces neither the passage wall surface of the sub passage 134 and the cover 200.

The support body 401 has a first side surface 407 and a second side surface 408 that are disposed at positions opposite to each other in the flow direction of the measurement target gas in the sub passage 134. The first side surface 407 faces an upstream side in the flow direction of the measurement target gas on a sub passage inlet 131 side in the sub passage 134. The second side surface 408 faces a downstream side in the flow direction of the measurement target gas on a second outlet 133 side in the sub passage 134. The first side surface 407 and the second side surface 408 are formed in the sub passage 134 such that the first side surface 407 and the second side surface 408 extend in the X axis direction between a pair of opposing side wall surfaces 152b of the second sub passage groove 152.

When the support body 401 is viewed from the upstream side in the flow direction of the measurement target gas through the sub passage 134, the support body 401 is disposed at a position where the first side surface 407 is exposed in the sub passage 134. The first side surface 407 forms a dynamic pressure receiving portion that receives a dynamic pressure of a measurement target gas flowing through the sub passage 134. The first side surface 407 receives a dynamic pressure of a measurement target gas by making a portion of the measurement target gas that flows in the sub passage 134 from the sub passage inlet 131 side toward the second outlet 133 side impinge on the first side surface 407. As a result, the first side surface 407 deflects the flow of the measurement target gas so as to take in the measurement target gas into the third passage portion D3.

The first side surface 407 is an inclined surface that is inclined with respect to the flow direction of the measurement target gas. The first side surface 407 is inclined in a direction gradually shifting from the first passage portion D1 side toward the third passage portion D3 side along the stacking direction as the first side surface 407 shifts in the flow direction of the measurement target gas in the sub passage 134. That is, the first side surface 407 is inclined so as to gradually shift from the front surface 403 side to the back surface 402 side of the support body 401 along the stacking direction as the first side surface 407 shifts from the end on one side in the width direction (Z-axis direction) of the distal end portion 401B toward the other side along the width direction. With the formation of the inclination of the first side surface 407, the measurement target gas that receives a passive dynamic pressure can be positively guided in the direction toward the third passage portion D3.

When the support body 401 is viewed from the downstream side in the flow direction of the measurement target gas through the sub passage 134, the support body 401 is disposed at a position where the second side surface 408 is exposed in the sub passage 134. The second side surface 408 is an inclined surface that is inclined with respect to the flow direction of the measurement target gas in the same manner as the first side surface 407. The second side surface 408 is inclined so as to gradually shift from the front surface 403 side to the back surface 402 side along the stacking direction as the second side surface 408 shifts from the end on the other side in the width direction (Z-axis direction) of the distal end portion 401B toward the one side along the width direction. The second side surface 408, in a case where the measurement target gas flows in the sub passage 134 in a reverse direction from the second outlet 133 side to the sub passage inlet 131 side due to the pulsation or the like in the main passage, receives a dynamic pressure of a measurement target gas by making a portion of the measurement target gas flowing in the reverse direction impinge on the second side surface 408. As a result, the second side surface 408 deflects the flow of the measurement target gas so as to take in the measurement target gas into the third passage portion D3.

A recessed portion 202 is formed in a region portion of the cover 200 that faces the distal end portion 401B of the support body 401. The recessed portion 202 is formed such that a facing region portion of the inner wall surface of the cover 200 that faces the support body 401 is recessed in the stacking direction with respect to a surrounding of the facing region portion, that is, a region portion disposed upstream of the facing region portion and a region portion disposed downstream of the facing region portion. The recessed portion 202 is slightly larger in the width direction than the distal end portion 401B of the support body 401, and is disposed in an extending manner between the pair of side wall surfaces 152b of the second sub passage groove 152. The third passage portion D3 is formed by a gap between the recessed portion 202 and the support body 401.

The cover 200 has the recessed portion 202, an inner wall surface 201 that is continuously formed with the recessed portion 202 by way of a stepped portion 204 disposed on a sub passage inlet 131 side (upstream side in the flow direction of the measurement target gas) of the sub passage 134, and an inner wall surface 203 that is continuously formed with the recessed portion 202 by way of a stepped portion 205 disposed on a second outlet 133 side (downstream side in the flow direction of the measurement target gas) of the sub passage 134. The inner wall surfaces 201, 203 extend parallel to the bottom wall surface 152a of the second sub passage groove 152 along the flow direction of a measurement target gas. The recessed portion 202 is formed such that the recessed portion 202 is recessed by one step from the inner wall surfaces 201, 203 and extends parallel to the back surface 402 of the support body 401.

The inlet of the third passage portion D3 is bent into a crank shape by a cooperative forming of the stepped portion 204 of the cover 200 and the first side surface 407 of the support body 401. With this cranked shape, it is possible to adjust a ratio at which a measurement target gas that has passively received a dynamic pressure by the first side surface 407 is taken into the first passage portion D1 and the third passage portion D3.

Next, advantageous effects acquired by the above-described configuration will be described.

According to the physical quantity detection device 20 of the present embodiment, the inside of the sub passage 134 is divided into the first passage portion D1, the second passage portion D2, and the third passage portion D3 in the stacking direction in the portion where a flow rate is detected, and the flow rate sensor 411 is disposed in the first passage portion D1. The second passage portion D2 and the third passage portion D3 are disposed on both sides of the first passage portion D1 in the stacking direction. With such a configuration, when contaminants that include water droplets, oil, dust, and the like enter the sub passage 134, the contaminants are dispersed three passage portions formed of the first to third passage portions D1 to D3. Accordingly, an amount of contaminants that reaches the flow rate sensor 411 disposed in the second passage portion D2 can be reduced.

According to the physical quantity detection device of the present embodiment, the third protrusion 304 of the circuit board 300 and the support body 401 are brought into contact with neither the bottom wall surface 152a of the second sub passage groove 152 nor the cover 200 and hence, the first passage portion D1 is disposed at a position floating in the air in the sub passage 134. The flow rate sensor 411 that is mounted on the first passage portion D1 is disposed at the position where the flow rate sensor 411 faces only the third protrusion 304 of the circuit board 300 and faces neither the passage wall surface of the sub passage 134 nor the cover 200. Accordingly, for example, in a case where contaminants such as water droplets and oil components move along the wall surface of the sub passage 134, or in a case where contaminants such as water droplets that adhere to the wall surface of the sub passage 134 due to dew condensation move along the wall surface, it is possible to positively guide the contaminants to the second passage portion D2 and the third passage portion D3 thus preventing the contaminants from entering the first passage portion D1 and preventing the contaminants from adhering to the flow rate sensor 411.

Particularly, the present embodiment adopts the configuration where the physical quantity detection device 20 is mounted on the main passage 22 such that the measurement unit 113 extends vertically. Accordingly, there is a possibility that contaminants such as water droplets and oil components sucked to a position above the flow rate sensor 411 in the sub passage 134 and contaminants such as dew condensation water generated at a position above the flow rate sensor 411 may move to an area in the vicinity of the flow rate sensor 411 by crawling the passage wall of the sub passage 134.

On the other hand, in the present embodiment, the third protrusion 304 of the circuit board 300 and the sensor assembly 400 are disposed away from the bottom wall surface 152a of the second sub passage groove 152 and the inner wall surface 203 of the cover 200 and hence, the third protrusion 304 of the circuit board 300 and the sensor assembly 400 are disposed in a state of floating in the air in the sub passage 134. Accordingly, for example, when the contaminants flow down from above along the passage wall of the sub passage 134, it is possible to make the contaminants pass through the second passage portion D2 and the third passage portion D3 and drop downward as they are. As a result, it is possible to prevent the contaminants in a liquid form from entering the first passage portion D1 and adhering to the flow rate sensor 411.

According to the physical quantity detection device 20 of the present embodiment, the first side surface 407 of the support body 401 is disposed at the position that faces the flow direction of the measurement target gas and hence, the first side surface 407 forms a dynamic pressure receiving portion that receives a dynamic pressure of a measurement target gas that flows through the sub passage 134.

Accordingly, the first side surface 407 can receive a dynamic pressure of a measurement target gas by making a portion of the measurement target gas that flows in the sub passage 134 impinge on the first side surface 407. As a result, the first side surface 407 deflects the flow of the measurement target gas so as to take in the measurement target gas into the third passage portion D3. Therefore, it is possible to suppress the intrusion of contaminants such as dust and water droplets contained in the measurement target gas into the second passage portion D2.

Particularly, the first side surface 407 is inclined so as to gradually shift from the front surface 403 side to the back surface 402 side of the support body 401 as the first side surface 407 shifts from the end on one side in the width direction (Z-axis direction) of the distal end portion 401B toward the other side along the width direction, that is the flow direction of a measurement target gas. With the formation of the inclination of the first side surface 407, the measurement target gas that receives a passive dynamic pressure can be positively guided in the direction toward the third passage portion D3.

According to physical quantity detection device 20 of the present embodiment, the recessed portion 202 is formed in the region portion of the cover 200 that faces the distal end portion 401B of the support body 401, and the third passage portion D3 is formed between the recessed portion 202 and the support body 401. The inlet of the third passage portion D3 is bent into a cranked shape by a cooperative forming of the stepped portion 204 of the cover 200 and the first side surface 407 of the support body 401. With this cranked shape, it is possible to adjust a ratio at which a measurement target gas that has passively received a dynamic pressure by the first side surface 407 is taken into the first passage portion D1 and the third passage portion D3. Further, by bending the third passage portion D3 into a cranked shape, it is possible to generate a capillary phenomenon. Accordingly, it is possible to positively take contaminants into the third passage portion D3, to make the contaminants pass through the third passage portion D3, and to discharge the contaminants.

(Modification 1) Next, a modification 1 of the present embodiment will be described.

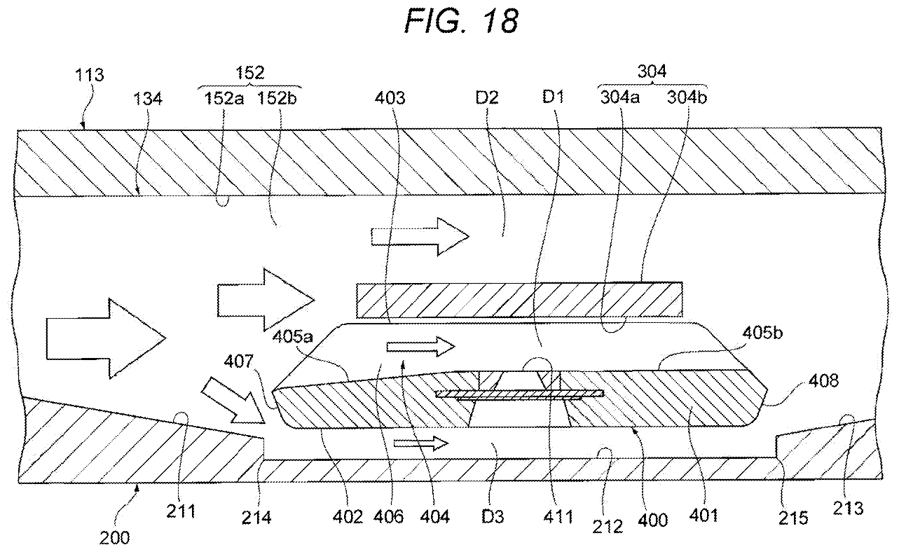

FIG. 18 is a view illustrating the modification of the configuration illustrated in FIG. 17.

A characteristic feature of the present modification lies in that inner wall surfaces 211, 213 of a cover 200 are inclined.

The cover 200 has a recessed portion 202, an inner wall surface 211 (upstream region portion) that is continuously formed with the recessed portion 202 by way of a stepped portion 214 disposed on a sub passage inlet 131 side that is an upstream side of the recessed portion 202 in a flow direction of a measurement target gas, and an inner wall surface 213 that is continuously formed with the recessed portion 202 by way of a stepped portion 215 disposed on a second outlet 133 side that is a downstream side of the recessed portion 202 in the flow direction of a measurement target gas. The inner wall surface 211 is inclined so as to shift in a direction away from a bottom wall surface 152a of a second sub passage groove 152, that is, in a direction approaching from a first passage portion D1 side to a third passage portion D3 side along a stacking direction in which a third protrusion 304 and a support body 401 face each other as shifting toward a downstream side along the flow direction of the measurement target gas. The inner wall surface 213 is inclined so as to shift in a direction approaching the bottom wall surface 152a of the second sub passage groove 152, that is, in a direction shifting from the third passage portion D3 side to the first passage portion D1 side along the stacking direction in which the third protrusion 304 and a support body 401 face each other as shifting toward the downstream side along the flow direction of the measurement target gas.

The inclination of the inner wall surface 211 of the cover 200 can increase a dynamic pressure that a first side surface 407 of the support body 401 receives. Accordingly, the inner wall surface 211 can more positively deflect a measurement target gas that flows in a sub passage 134 toward the third passage portion D3 and hence, a flow rate of the measurement target gas taken into the third passage portion D3 can be increased. Then, the contaminants contained in the measurement target gas are guided to the third passage portion D3 and hence, an amount of contaminants that flows into the first passage portion D1 can be reduced. Accordingly, the anti-contamination property of a flow rate sensor 411 in the first passage portion D1 can be further improved.

In a case where a reverse flow occurs in the sub passage 134 due to pulsation, an inner wall surface 212 of the cover 200 can, in the same manner as the inner wall surface 211, increase a dynamic pressure of a measurement target gas that a second side surface 408 of a support body 401 receives by the inclination of the inner wall surface 212. Accordingly, the inner wall surface 212 can more positively deflect the measurement target gas that flows in a sub passage 134 toward the third passage portion D3 and hence, a flow rate of the measurement target gas taken into the third passage portion D3 can be increased. Then, the contaminants contained in the measurement target gas are guided to the third passage portion D3 and hence, the anti-contamination property of the flow rate sensor 411 can be improved.

(Modification 2) Next, a modification 2 of the present embodiment will be described.

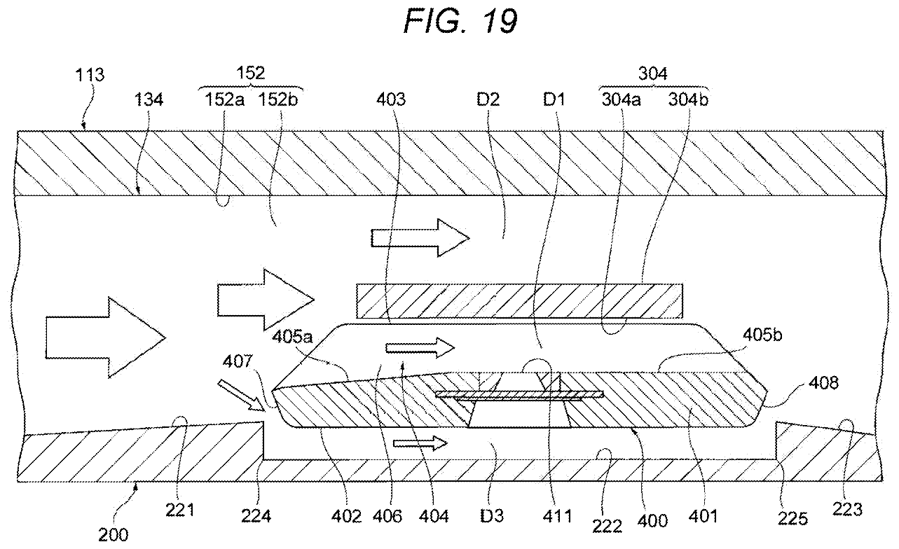

FIG. 19 is a view illustrating the modification of the configuration illustrated in FIG. 17. A characteristic feature of the present modification lies in that inner wall surfaces 221, 223 of a cover 200 are inclined in a reverse direction opposite to the direction used in the modification 1.

A cover 200 has a recessed portion 202, an inner wall surface (upstream region portion) 221 that is continuously formed with the recessed portion 202 by way of a stepped portion 224 disposed on a sub passage inlet 131 side that is an upstream side of the recessed portion 202 in a flow direction of a measurement target gas, and an inner wall surface 223 that is continuously formed with the recessed portion 202 by way of a stepped portion 225 disposed on a second outlet 133 side of the recessed portion 202. The inner wall surface 221 is inclined so as to shift in a direction approaching the bottom wall surface 152a of the second sub passage groove 152, that is, in a direction shifting from the third passage portion D3 side to the first passage portion D1 side along the stacking direction in which the third protrusion 304 and a support body 401 face each other as shifting toward the downstream side along the flow direction of the measurement target gas. The inner wall surface 223 is inclined so as to shift in a direction away from the bottom wall surface 152a of the second sub passage groove 152, that is, in a direction shifting from the first passage portion D1 side to the third passage portion D3 side as shifting toward the downstream side along the flow direction of the measurement target gas.

The inclination of the inner wall surface 221 of the cover 200 can decrease a dynamic pressure that a first side surface 407 of a support body 401 receives. Accordingly, the inner wall surface 221 can deflect a measurement target gas that flows in a sub passage 134 toward the first passage portion D1 and hence, a flow rate of the measurement target gas taken into the third passage portion D3 can be decreased. As a result, a flow velocity of a measurement target gas that flows into the first passage portion D1 can be improved, and a flow rate can be measured with high accuracy. Further, a portion of the measurement target gas can be also taken into the third passage portion D3 and hence, both the anti-contamination property and the flow rate measurement accuracy can be achieved.

In a case where a reverse flow occurs in the sub passage 134 due to pulsation, an inner wall surface 223 of the cover 200 can, in the same manner as the inner wall surface 221, decrease a dynamic pressure of a measurement target gas that a second side surface 408 of a support body 401 receives by the inclination of the inner wall surface 223. Accordingly, the inner wall surface 223 can deflect the measurement target gas that flows in a sub passage 134 toward the first passage portion D1 and hence, a flow rate of the measurement target gas taken into the third passage portion D3 can be decreased. As a result, a flow velocity of a measurement target gas that flows into the first passage portion D1 can be improved, and a flow rate can be measured with high accuracy.

(Modification 3) Next, a modification 3 of the present embodiment will be described.

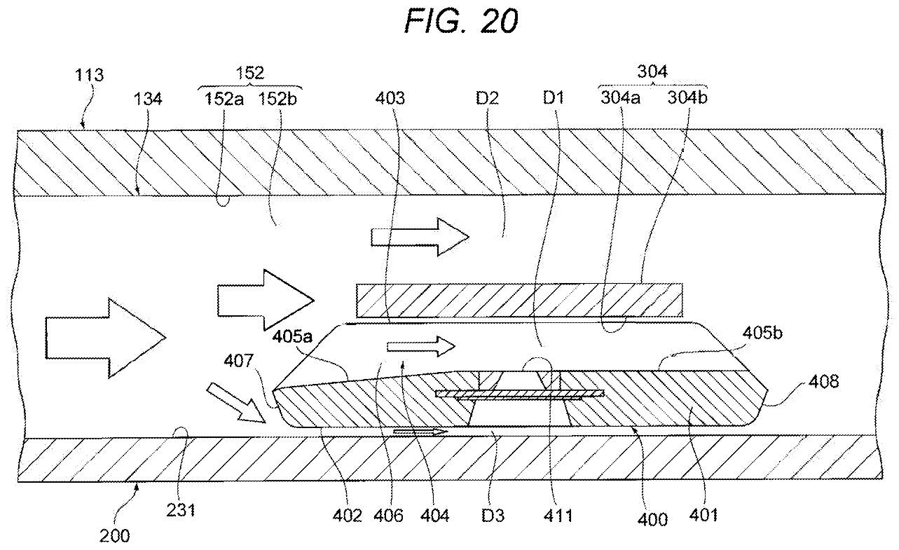

FIG. 20 is a view illustrating a modification of the configuration illustrated in FIG. 17. A characteristic feature of the present modification lies in that the recessed portion 202 of the cover 200 is omitted.

The cover 200 has an inner wall surface 231 that extends in parallel with a bottom wall surface 152a of a second sub passage groove 152. An inner wall surface 231 has a flat shape that follows the flow direction of a measurement target gas. Accordingly, a third passage portion D3 formed between the inner wall surface 231 of the cover 200 and a back surface 402 of a support body 401 has a shape extending linearly with a third gap.

In the modification 3, in the same manner as the embodiment and the modifications described above, the first side surface 407 of the support body 401 is disposed at the position that faces the flow direction of the measurement target gas and hence, the first side surface 407 forms a dynamic pressure receiving portion that receives a dynamic pressure of a measurement target gas that flows through the sub passage 134. Accordingly, the first side surface 407 can receive a dynamic pressure of a measurement target gas by making a portion of the measurement target gas that flows in the sub passage 134 impinge on the first side surface 407. As a result, the first side surface 407 deflects the flow of the measurement target gas so as to take in the measurement target gas into the third passage portion D3. Therefore, it is possible to suppress the intrusion of contaminants such as dust and water droplets contained in the measurement target gas into the second passage portion D2.

Particularly, in the present modification, the third passage portion D3 has a linearly extending shape. Further, it is possible to generate a capillary phenomenon in the third passage portion D3. Accordingly, it is possible to positively take contaminants into the third passage portion D3, to make the contaminants pass through the third passage portion D3, and to discharge the contaminants and hence, the anti-contamination property of the flow rate sensor 411 can be improved.

Although the embodiments of the present invention have been described in detail above, the present invention is not limited to the above embodiments, and various design changes can be made without departing from the spirit of the present invention described in claims. For example, the above-described embodiments have been described in detail for facilitating the understanding of the present invention. However, the embodiments are not necessarily limited to the flow rate measurement device that includes all configurations described above. A part of the configuration of one embodiment can be replaced with the configuration of another embodiment, and the configuration of another embodiment can be added to the configuration of one embodiment. Further, with respect to parts of the configurations of the respective embodiments, the addition, the deletion and the replacement of other configurations can be made.

### REFERENCE SIGNS LIST

2 measurement target gas
20 physical quantity detection device (flow rate measurement device)
100 housing
131 sub passage inlet
133 second outlet
134 sub passage
200 cover
202 recessed portion
300 circuit board
304 third protrusion (board)
400 sensor assembly
401 support body
404 recessed groove
407 first side surface
408 second side surface
411 flow rate sensor
150 sub passage groove
D1 first passage portion
D2 second passage portion
D3 third passage portion

1. A flow rate measurement device provided with a sub passage into which a portion of a measurement target gas that flows through a main passage is taken, the flow rate measurement device comprising:
a board that is disposed in the sub passage along a flow direction of the measurement target gas;
a support body that is disposed such that the support body faces one surface of the board in the sub passage so as to overlap with the board in a direction that intersects with a flow direction of the measurement target gas; and
a flow rate sensor that faces one surface of the board in a state where the flow rate sensor is supported on the support body, and measures a flow rate of the measurement target gas passing between the support body and the board,
wherein
the sub passage includes a first passage portion having a first gap through which the measurement target gas passes between the support body and the one surface of the board, a second passage portion having a second gap through which the measurement target gas passes between the other surface of the board and a passage wall surface of the sub passage that faces the other surface of the board, and a third passage portion having a third gap through which the measurement target gas passes between the support body and the passage wall surface of the sub passage that faces the support body, and
the support body has a side surface faces in a flow direction of the measurement target gas in the sub passage.

2. The flow rate measurement device according to claim 1, wherein the side surface is inclined in a direction gradually shifting from the first passage portion side toward the third passage portion side as the side surface shifts in the flow direction of the measurement target gas in the sub passage.

3. The flow rate measurement device according to claim 1, wherein the passage wall surface of the sub passage includes a facing region portion that faces the support body and an upstream region portion that is continuously formed with an upstream side of the facing region portion in a flow direction of the measurement target gas by way of a stepped portion, and the facing region portion is disposed at a position more away from the support body than the upstream region portion.

4. The flow rate measurement device according to claim 3, wherein the upstream region portion is inclined so as to shift in a direction approaching the facing region portion along a direction in which the board and the support body face each other as shifting to a downstream side in a flow direction of the measurement target gas.

5. The flow rate measurement device according to claim 3, wherein the upstream region portion is inclined so as to shift in a direction away from the facing region portion along a direction in which the board and the support body face each other as shifting to a downstream side in a flow direction of the measurement target gas.

6. The flow rate measurement device according to claim 3, wherein in the passage wall surface of the sub passage, the facing region portion that faces the support body is recessed more than a periphery of the facing region portion.
